(19) United States
(12) Patent Application Publication
(10) Pub. No.: US 2010/0217502 A1
(43) Pub. Date: Aug. 26, 2010

(54) Fuel management system for a motor vehicle

(76) Inventor: Michel Bouchard, St - Hyacinthe (CA)

Correspondence Address: Michel Bouchard, # 106, 3591 Gouin E., Montreal, QC, H1H 5V7, CA

(21) Appl. No.: 12/697,186

(22) Filed: Jan. 29, 2010

(30) Foreign Application Priority Data
Feb. 20, 2009 (GB) 0902885.3

(51) Int. Cl. F02D 41/00

(52) U.S. Cl. 701/103; 701/112

(57) ABSTRACT

A fuel management system for a motor vehicle has a means for shutting down the engine when the accelerator is released and the vehicle slows down, as measured by the engine's deceleration sensor. Moreover, when the transmission is put to park, or in the case of a manual transmission, when the parking brake is engaged, the engine shuts off.

This application claims priority based on UK grant of a patent 0902885.3 filed Feb. 20, 2009

### FIELD OF THE INVENTION

The present invention relates generally to vehicle engines but more particularly to a system which helps reduce fuel consumption in motor vehicle by managing idle time and slowing down periods.

### BACKGROUND OF THE INVENTION

With he emphasis on fuel economy, green gas reduction and other environmental factors, many inventions have been developed in regards to fuel management in motor vehicles.

### SUMMARY OF THE INVENTION

In view of the foregoing disadvantages inherent in the known devices now present in the prior art, the present invention, which will be described subsequently in greater detail, is to provide objects and advantages which are:

To provide for a fuel economy system that respects all issues concerning green gas emission and other environmental factors.

To attain these ends, the present invention generally comprises an engine; an accelerator pedal; a deceleration sensor; and an engine shut down mechanism, such that when the engine is running and the deceleration sensor detects a specific decrease in deceleration the engine shut down mechanism will shut down the engine, thereby conserving fuel when the engine does not require more fuel.

The fuel management system also has an engine restart mechanism, wherein after a predetermined time interval the engine restart mechanism will restart the engine.

The fuel management system also has a transmission mechanism and a transmission sensor, such that when the transmission mechanism is placed in an idle position the transmission sensor sends a signal to the engine shut down mechanism to shut down the engine.

A hand brake mechanism and a hand brake sensor, such that when the hand brake mechanism is engaged the hand brake sensor sends a signal to the engine shut down mechanism to shut down the engine.

An hour meter that measures the number of hours and minutes the engine was shut down.

A computer member including fuel efficiency computer software; a USB cable; and a USB port; such that the computer member is adapted to receive information from the hour meter and display results based upon the fuel efficiency computer software.

A green light indicator adapted to indicate to a driver that the instant motor vehicle is equipped with the fuel management system, and that the fuel management system is activated.

A combination of a motor vehicle and a fuel management system comprising a motor vehicle; an engine; an accelerator pedal; a deceleration sensor; and an engine shut down mechanism, such that when the engine is running and the deceleration sensor detects a specific decrease in deceleration the engine shut down mechanism will shut down the engine, thereby conserving fuel when the engine does not require more fuel.

The combination further comprising an engine restart mechanism, wherein after a predetermined time interval the engine restart mechanism will restart the engine.

The combination further comprising a transmission mechanism and a transmission sensor, such that when the transmission mechanism is placed in an idle position the transmission sensor sends a signal to the engine shut down mechanism to shut down the engine.

The combination further comprising a hand brake mechanism and a hand brake sensor, such that when the hand brake mechanism is engaged the hand brake sensor sends a signal to the engine shut down mechanism to shut down the engine.

The combination further comprising an hour meter that measures the number of hours and minutes the engine was shut down.

Other features include a gear changing means and a gear changing sensoring means, such that when the changing means is placed in an idle position the gear changing sensoring means sends a signal to the shut down means to shut down the motoring means. A hand braking means and a hand braking sensoring means, such that when the hand braking means is engaged the hand braking sensoring means sends a signal to the shut down means to shut down the motoring means. An hour metering means that measures the number of hours and minutes the motoring means was shut down; a computing means including fuel efficiency computer software; a USB cable; and a USB port; such that the computing means is adapted to receive information from the hour metering means and display results based upon the fuel efficiency computer software.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Schematic view of the invention.

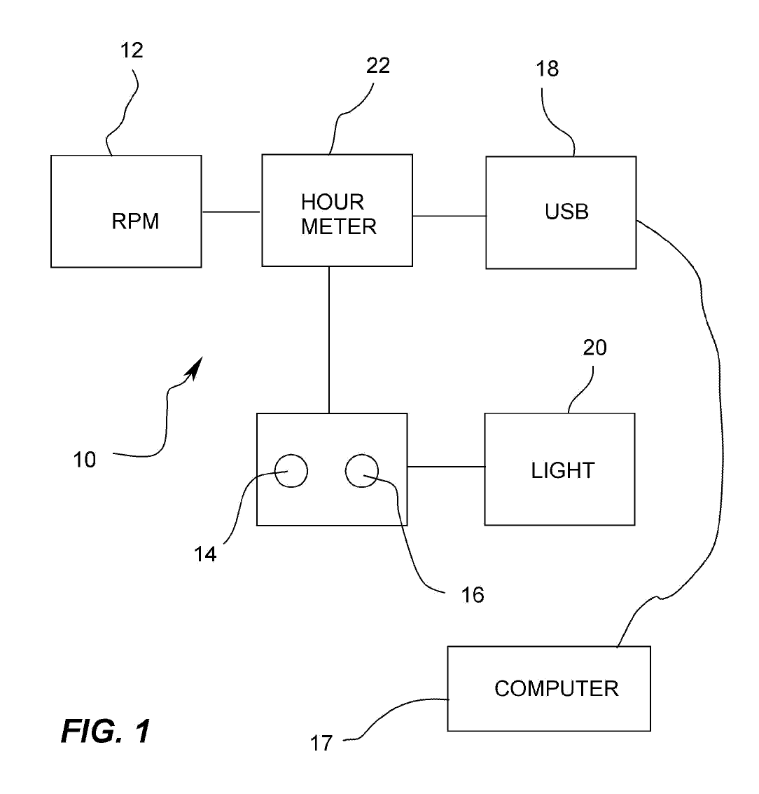

### DETAILED DESCRIPTION OF THE PREFERRED EMBODIMENT

A fuel management system for a motor vehicle (10) is connected to the deceleration sensor (12) of an automobile (not shown) comprises an engine shut down means (14) which is triggered when the car accelerator (not shown) is released and the vehicle slows down. The engine won't restart for at least 10 seconds to realize fuel economy. The system is triggered when there is a rather large deceleration that occurs. This can occur, for example, when slowing down at a red light, wherein the vehicle comes to a complete stop, or when slowing down at a highway exit, when the vehicle goes from a high speed to a substantially lower speed.

The engine shut down means (14) is also triggered by the transmission placed on park or hand brake engaged. This time it is for a delay of 5 minutes. If the car is parked for more than five minutes, the driver should reengage the transmission or hand brake so as to engage the restart (16) of the system (10). For longer periods, the user should simply turn off the ignition since it appears that he may need to stay still for a long period of time.

In order to know how much fuel was saved, a user can plug a USB cable into a USB port (18) to read the results on a computer (17) from the number of hours and minutes the engine was shut based on the measurement of an hour meter (22) which counts how many hours and minutes the engine was shut off by way of the system (10).

As an added feature, a green light indicator (20), for the benefit of other drivers, indicate that the vehicle is equipped with a fuel management system for a motor vehicle (10) so as to sensitize others to the benefits. The light indicator (20) turns on when the system is on, and is located at an appropriate location, such as the rear window.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A fuel management system for motor vehicles comprising an engine;
an accelerator pedal; a deceleration sensor; and an engine shut down mechanism, such that when said engine is running and said deceleration sensor detects a specific decrease in deceleration said engine shut down mechanism will shut down said engine, thereby conserving fuel when said engine does not require more fuel.)

2. The fuel management system of claim 1, further comprising an engine restart mechanism, wherein after a predetermined time interval said engine restart mechanism will restart said engine.)

3. The fuel management system of claim 1, further comprising a transmission mechanism and a transmission sensor, such that when said transmission mechanism is placed in an idle position said transmission sensor sends a signal to said engine shut down mechanism to shut down said engine.)

4. The fuel management system of claim 1, further comprising a hand brake mechanism and a hand brake sensor, such that when said hand brake mechanism is engaged said hand brake sensor sends a signal to said engine shut down mechanism to shut down said engine.)

5. The fuel management system of claim 1, further comprising an hour meter that measures the number of hours and minutes said engine was shut down.)

6. The fuel management system of claim 5, further comprising a computer member including fuel efficiency computer software; a USB cable; and a USB port; such that said computer member is adapted to receive information from said hour meter and display results based upon said fuel efficiency computer software.)

7. The fuel management system of claim 1, further comprising a green light indicator adapted to indicate to a driver that the instant motor vehicle is equipped with said fuel management system, and that said fuel management system is activated.)

8. A combination of a motor vehicle and a fuel management system comprising a motor vehicle; an engine; an accelerator pedal; a deceleration sensor; and an engine shut down mechanism, such that when said engine is running and said deceleration sensor detects a specific decrease in deceleration said engine shut down mechanism will shut down said engine, thereby conserving fuel when said engine does not require more fuel.)

9. The combination of claim 8, further comprising an engine restart mechanism, wherein after a predetermined time interval said engine restart mechanism will restart said engine.)

10. The combination of claim 8, further comprising a transmission mechanism and a transmission sensor, such that when said transmission mechanism is placed in an idle position said transmission sensor sends a signal to said engine shut down mechanism to shut down said engine.)

11. The combination of claim 8, further comprising a hand brake mechanism and a hand brake sensor, such that when said hand brake mechanism is engaged said hand brake sensor sends a signal to said engine shut down mechanism to shut down said engine.

12. The combination of claim 8, further comprising an hour meter that measures the number of hours and minutes said engine was shut down.)

13. The combination of claim 12, further comprising a computer member including fuel efficiency computer software; a USB cable; and a USB port; such that said computer member is adapted to receive information from said hour meter and display results based upon said fuel efficiency computer software.)

14. The combination of claim 8, further comprising a green light indicator adapted to indicate to a driver that the instant motor vehicle is equipped with said fuel management system, and that said fuel management system is activated.)

15. A fuel management system for motor vehicles comprising motoring means; accelerating means; deceleration sensing means; and shutting down means for shutting down said motoring means, such that when said motoring means is running and said deceleration sensing means detects a specific decrease in deceleration said shut down means will shut down said motoring means, thereby conserving fuel when said motoring means does not require more fuel.)

16. The fuel management system of claim 15, further comprising an restart means for restarting said motoring means, wherein after a predetermined time interval said restart means will restart said motoring means.)

17. The fuel management system of claim 15, further comprising a gear changing means and a gear changing sensoring means, such that when said changing means is placed in an idle position said gear changing sensoring means sends a signal to said shut down means to shut down said motoring means.)

18. The fuel management system of claim 15, further comprising a hand braking means and a hand braking sensoring means, such that when said hand braking means is engaged said hand braking sensoring means sends a signal to said shut down means to shut down said motoring means.)

19. The fuel management system of claim 15, further comprising an hour metering means that measures the number of hours and minutes said motoring means was shut down; a computing means including fuel efficiency computer software; a USB cable; and a USB port; such that said computing means is adapted to receive information from said hour metering means and display results based upon said fuel efficiency computer software.)

20. The fuel management system of claim 15, further comprising a green light indicator adapted to indicate to a driver that the instant motor vehicle is equipped with said fuel management system, and that said fuel management system is activated.
